(19) United States
(12) Patent Application Publication
(10) Pub. No.: US 2026/0338132 A1
(43) Pub. Date: Oct. 29, 2026

(54) DIFFERENTIAL EVAPORATION SYSTEM

(71) Applicant: Stéphane WILLOCX, Venice, FL (US)

(72) Inventor: Stéphane WILLOCX, Venice, FL (US)

(21) Appl. No.: 19/110,780

(22) PCT Filed: Sep. 19, 2023
(86) PCT No.: PCT/EP2023/075844

§ 371 Date: Mar. 11, 2025

(30) Foreign Application Priority Data
Sep. 20, 2022 (FR) FR2209502

(51) Int. Cl. F02G 1/053

(52) U.S. Cl. CPC F02G 1/053; F02G 2270/40

(57) ABSTRACT

A differential evaporation engine system including an enclosure having a cavity capable of containing a liquid and a gas mixture, a hot source configured to heat the liquid, a cold source configured to cool the gas mixture, a movable element configured to move inside the enclosure, the movable element including at least one plunger element the plunger element being configured so as to be at least partially immersed in the liquid in a first configuration and alternatively in contact with the gas mixture in a second configuration. The at least one plunger element has a porous surface, so as to increase the evaporation area without increasing the area of the liquid.

### TECHNICAL FIELD

The present invention relates to the field of energy transformation devices and more particularly to thermal engines and machines. The invention will find particular application in differential evaporation pressure engines.

### STATE OF THE ART

In the field of engines, the Stirling engine is well known, utilising a temperature difference applied to a gas in a closed enclosure to produce mechanical energy. Engines that reproduce a Rankine cycle by converting heat into mechanical work are also known. However, these engines have the drawback of often having unsatisfactory efficiency.

There are solutions capable of being used in an engine, such as that of document WO2016034632A1 having a differential evaporation engine comprising: an enclosure with a liquid and a working mixture, a cold source capable of cooling the working mixture, a hot source configured to heat the liquid, a movable element, disposed inside the enclosure so as to create conditions for evaporation of the liquid or condensation of the working mixture.

This type of engine is configured so that heat exchange occurs between the working mixture and the hot and cold sources. This type of engine has a high efficiency and many advantages. Naturally, it would be advantageous to further improve the efficiency and/or power of this type of engine.

One object of the present invention is therefore to provide a solution which makes it possible to increase efficiency and/or power of differential evaporation engines.

Further objects, characteristics and advantages of the present invention will become apparent upon examining the following description and the appended drawings. It is understood that other advantages may be incorporated.

### SUMMARY

To achieve this objective, according to one embodiment, a differential evaporation engine system is provided comprising:
an enclosure having a cavity capable of containing a liquid and a gas mixture,
a hot source configured to heat the liquid,
a cold source configured to cool the gas mixture,
a movable element configured to move inside the enclosure, the movable element comprising at least one plunger element, the plunger element being configured so as to be at least partially immersed in the liquid in a first configuration and alternatively in contact with the gas mixture in a second configuration, the second configuration being different from the first configuration, in the second configuration, the plunger element being not immersed in the liquid or being less immersed in the liquid than in the first configuration.

The engine is configured so that the at least one plunger element has a porous surface, the plunger element being configured so that, in the first configuration, the porous surface is impregnated with a portion of the liquid and, in the second configuration, said portion of the liquid evaporates at least partially in contact with the gas mixture.

The plungers make it possible to increase the evaporation area of the liquid in contact with the gas mixture without increasing the volume of the enclosure. In other words, the present invention makes it possible to maintain a constant working volume while increasing the soaking area on which an evaporation and/or condensation phenomenon occurs. This leads to an unexpected increase in efficiency and/or power of the engine.

The invention preferentially makes it possible not to increase the parasitic working volume of a differential evaporation engine by increasing its evaporation or condensation area.

Unlike a Stirling engine, this technical solution enables operation with a much lower displaced volume of the gas mixture.

Thus, reduced overall dimensions are obtained for the whole differential evaporation engine for a power equivalent to a larger engine. The invention enables improvement of all systems using evaporation and/or condensation phenomena.

Without knowledge of the present invention, a person skilled in the art would increase power of differential evaporation engines by increasing, for example, power of the hot and cold sources or even dimension of the movable element.

Thus, the present invention avoids the need to increase the area of the liquid or to increase the size of the enclosure where the heat exchanges take place.

### BRIEF DESCRIPTION OF THE FIGURES

The purposes, objects, as well as the characteristics and advantages of the invention will appear better from the detailed description of one embodiment thereof which is illustrated by the following appended drawings, in which:

FIGS. 1A-1B represent a cross-section view of an example differential evaporation engine system having a movable element capable of being translationally driven and not comprising plunger elements in a second and a first configuration respectively.

FIGS. 2A-2B represent a cross-section view of an example differential evaporation engine system having a movable element capable of being translationally driven and comprising plunger elements in the second configuration and in the first configuration, respectively.

FIGS. 3A-3B respectively represent a cross-section view of an example differential evaporation engine having a movable element capable of being translationally driven and comprising plunger elements fastened to the movable element as well as additional plunger elements fastened inside of the enclosure in a second configuration and in a first configuration.

FIGS. 4A-4B respectively represent a front and side cross-section view of an example differential evaporation engine system having a movable element and comprising plunger elements capable of being rotationally driven along a transverse axis.

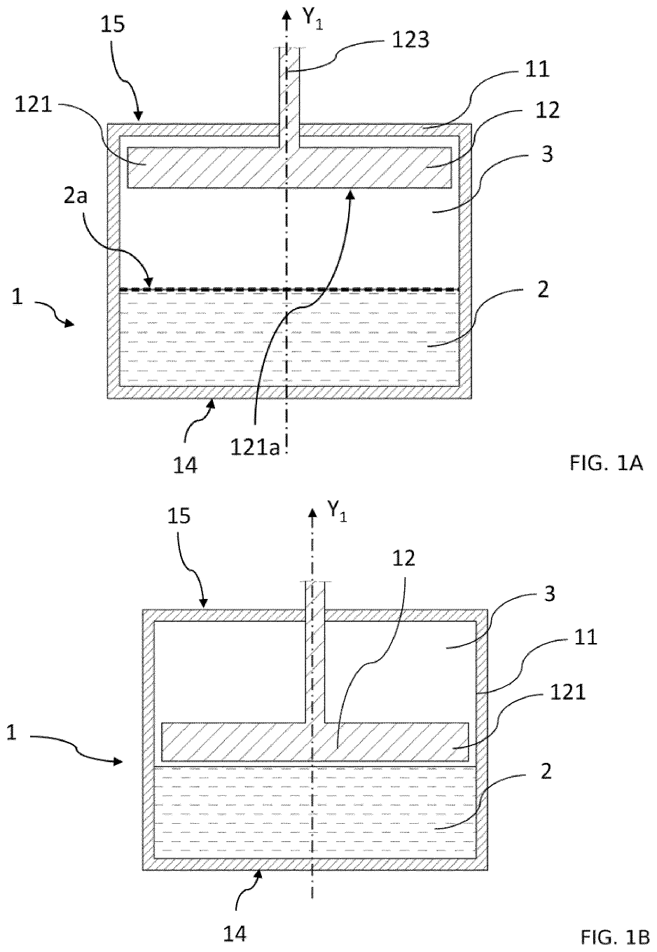

The drawings are provided as examples and are not restrictive of the invention. They are schematic representations to facilitate understanding of the invention and are not necessarily to the scale of practical applications. Cylinders or pistons are not represented in the drawings. For the sake of clarity, only the displacer is represented.

### DETAILED DESCRIPTION

Before starting a detailed review of embodiments of the invention, optional characteristics are stated hereinafter, which can possibly be used in combination or alternatively:

According to one example, the enclosure is configured so that the liquid has the gas thereabove along a main axis and that the movable element moves in a translational motion along the main axis.

According to one example, the main axis is vertical.

According to one example, the plunger element mainly extends along a direction parallel to the main axis.

According to one example, the movable element comprises a main portion having a lower surface normal to the main axis and the at least one plunger element extends from the lower surface, preferably the plunger element having a rod shape.

According to one example, the enclosure comprises at least one additional plunger element fixed relative to the enclosure and having an additional porous surface portion, the at least one additional plunger element extending into the enclosure from a lower enclosure face of the enclosure along a direction parallel to the main axis.

Preferably, the additional plunger elements are fixed relative to a top portion of the enclosure along the main axis.

According to one example, the main portion of the movable element defines a reservoir configured to contain an additional liquid and the engine is configured so that, in the second configuration, the at least one additional plunger element is soaked with the additional liquid.

According to one example, the motor comprises a plurality of additional plunger elements.

According to one example, the enclosure is configured so that the liquid has the gas thereabove along a main axis and that the movable element moves in a rotational motion along a secondary axis, orthogonal to the main axis.

According to one example, the porous surface covers the entire surface of the at least one plunger element.

According to one example, the pores of the porous surface each form a liquid retention cavity. This especially makes it possible to increase the amount of liquid retained on the elements having a porous surface, ultimately making it possible to increase evaporation.

Preferably, the liquid can only escape from the cavity through the entrance through which it has entered inside the cavity. According to one example, the retention pores or cavities are closed, they open outwardly but do not communicate with other pores or cavities.

Preferably, the retention cavities of the porous surface, namely the pores, each form a closed cavity towards the inside of the plunger element. Thus, according to this embodiment, liquid that enters the cavity can be retained in the cavity but does not enter further into the plunger element. Thus, the liquid does not pass through the plunger element neither from one side to the other nor to its centre. The liquid remains confined to the porous surface and the retention cavities formed by the pores of the porous surface. Thus, a plunger element formed of a wire mesh or a metal foam does not have retention cavities for the purposes of the invention.

The liquid retention cavities open outwardly of the plunger element so that the liquid can enter the retention cavity.

According to one example, the liquid retention cavities formed by the pores of the plunger element have a maximum dimension Dpores such that Dpores<1.5 mm (10-3 metre).

Preferably, Dpores<1 mm. Preferably, Dpores<0.8 mm. Preferably, Dpores<0.5 mm. Preferably, Dpores<0.3 mm. With these pore dimensions, the liquid retention area and therefore evaporation are increased. Furthermore, this does not disrupt circulation of fluids. Nor does it unnecessarily weigh down the plunger by loading it with an amount of liquid that does not have time to evaporate. The kinetics of the system is therefore improved. Its performance is increased.

Dpores is the maximum dimension in a least one dimension. Preferably, Dpores is the maximum dimension created by the opening of the pore at the surface of the porous surface. If the pores are portions of a sphere, then Dpores corresponds to the diameter of the circle formed by the opening of the pore at the surface of the porous surface.

According to one example, the engine comprises a plurality of plunger elements.

According to one example, the plunger elements are distant from one another so as to create a space for the gas to pass through in order to optimise evaporation of the liquid soaked on the porous surface by contact with the gas.

According to one example, the plunger elements are equidistant from one another.

According to one example, at least one plunger element is a rod and/or a cylinder. According to one embodiment, at least one plunger element has a hollow portion.

According to one example, at least one plunger element has at least one opening configured to enable circulation of the liquid or gas mixture as the engine passes from one of the first configuration and the second configuration to the other of the first configuration and the second configuration.

Preferably, the plunger element is a hollow tube with side openings.

According to one example, the plunger element or the porous surface of the plunger element is made of wood or a composite material or sponge or a fabric.

According to one example, the plunger element or the porous surface of the plunger element is made of oxidised metal.

According to one example, the plunger element or the porous surface of the plunger element is made of a material having a thermal conductivity of less than or equal to 10 W·m⁻¹·K⁻¹ (Watt/(metre*kelvin)).

According to one example, the plunger element is made of a material having a thermal conductivity of strictly less than 10 W·m−1·K−1, preferably less than 8 W·m−1·K−1, preferably less than 5 W·m−1·K−1 and preferably less than 3 W·m−1·K−1.

According to one example, the plunger element is made of a material having a thermal conductivity of less than or equal to 1 W·m-1·K−1.

This especially makes it possible to avoid interfering with the evaporation and condensation process with the gas mixture. Indeed, evaporation of the liquid would cool a plunger having a high thermal conductivity and would cool the heating liquid during its reintegration into the liquid.

According to one example, the porous surface of the at least one plunger element is made of a material having a thermal conductivity of strictly less than 10W·m−1·K−1, preferably less than 8 W·m−1·K−1, preferably less than 5 W·m−1·K−1 and preferably less than 3W·m−1·K−1. According to one example, the porous surface of the at least one plunger element is made of a material having a thermal conductivity of less than or equal to 1 W·m−1·K−1.

According to one example, the porous surface of the at least one plunger element is, preferably entirely, made of a porous material and takes the shape of at least one of the following typologies: ridges, strips, grids, sticks, sponges or a mesh. Thus, the porous surface forms a topology. The reliefs forming this topology are formed by or covered with the porous material. The pores are distinct from the reliefs formed by this topology.

According to one example, the reliefs forming the typology have a maximum dimension Drelief such that Drelief≥3*Dpores. Preferably, Drelief≥5*Dpores. Preferably, Drelief≥10*Dpores. According to one example, Drelief>1 mm (10-3 metre). According to one example, Drelief>2 mm (10-3 metre). According to one example, Drelief>5 mm (10-3 metre). According to one example, Drelief>10 mm (10-3 metre). Drelief is measured in a least one dimension.

The presence of these reliefs makes it possible to further increase the developed area of the porous surface. This makes it possible to increase the exchange area to enhance evaporation. This makes it possible to improve performance of the system.

According to one example, the cavity has a constant volume.

According to one example, the cavity extends along a main axis between a heating space and a cooling space so that the hot source can heat the liquid in the heating space via the side and/or lower faces and the cold source can cool the gas mixture in the cooling space.

It is specified that, within the context of the present invention, the term differential evaporation engine may be understood to refer only to a constituent portion of the engine. Thus, it may essentially refer to the enclosure in which the movement of the movable element takes place by virtue of the pressure differential created by the hot and cold sources.

By partial soaking of a liquid, it is meant an action that enables the contact surface of the movable element with the gas mixture to be soaked by the liquid and thus the liquid to be gripped by the movable element or deposited onto the movable element. In other words, an amount of liquid is taken from the first configuration to the second configuration.

By ‘movable element’ or ‘displacer’, it is meant a part that can move within the enclosure and may include plunger elements.

By ‘plunger element’, it is meant solid elements interdependent of the motion of the movable element.

It is specified that, within the context of the present invention, the terms ‘on’, ‘has thereabove’, ‘covers’, ‘underlying’, ‘opposite’ and their equivalents do not necessarily mean ‘in contact with’. The terms “substantially”, “about”, “in the range of” mean “within 10%, preferably within 5%” or, when it is an angular orientation, “within 10°”. Thus, a direction substantially normal to a plane means a direction having an angle of 90±10° with respect to the plane.

In the present patent application, the term movable corresponds to a rotational motion or to a translational motion or to a combination of motions, for example the combination of a rotation and a translation.

In the present patent application, when it is indicated that two parts are distinct, this means that these parts are separate. They are:
positioned at a distance from each other, and/or
movable relative to each other, and/or
integral with each other while being fastened by added elements, this fastening being dismountable or not.

Hence, a unitary one-piece part cannot consist of two distinct parts.

In the present patent application, the term “integral” used to describe the connection between two parts means that the two parts are connected/fastened with respect to each other, according to all degrees of freedom, unless otherwise explicitly specified. For example, if it is indicated that two parts are translationally integral along a direction X, this means that the parts can be movable relative to each other except along the direction X. In other words, if a part is moved along the direction X, the other part performs the same motion.

In the following detailed description, use may be made of terms such as “horizontal”, “vertical”, “longitudinal”, “transverse”, “upper”, “lower”, “top”, “bottom”, “front”, “rear”, “internal”, “external”. These terms should be interpreted in a relative manner in relation to the normal position of the differential evaporation engine system and the normal direction of progress of the user of the whole.

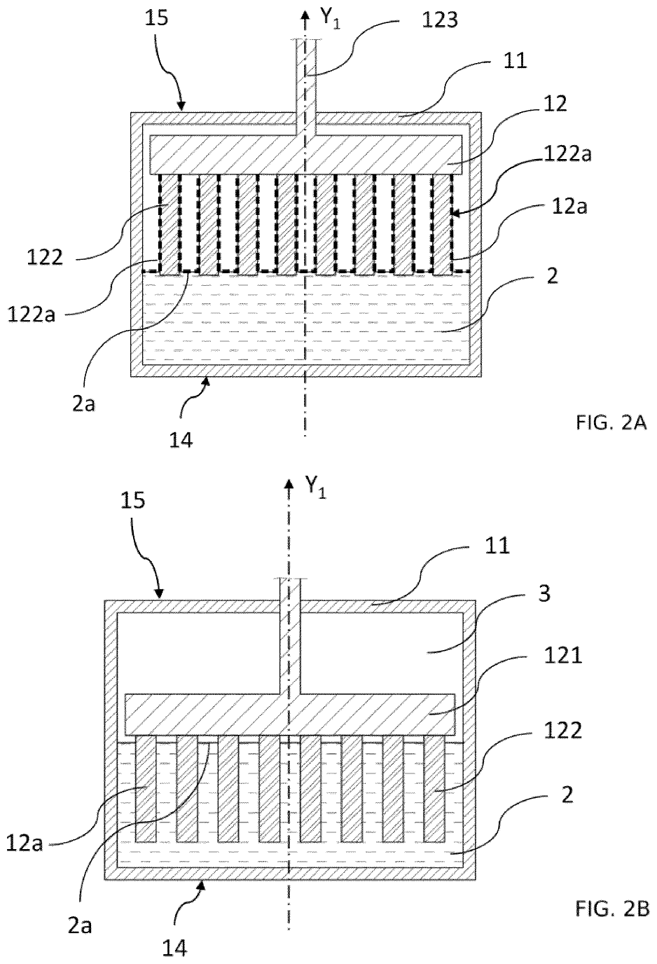

As illustrated in FIGS. 2A-4B, an example differential evaporation engine system 1 is represented, comprising an enclosure 11 capable of containing a liquid 2 and a gas mixture 3. The liquid 2 and the gas mixture 3 are advantageously distributed so that the liquid 2 has the gas mixture 3 thereabove along the main axis Y₁. Preferably, the liquid 2 extends from the bottom of the enclosure 11 and has a surface area 2a in contact with the gas mixture 3.

The system 1 comprises a hot source 14 configured to heat the liquid 2 present in the heating space. For example, the hot source 14 comprises a heating element. The system 1 also comprises a cold source 15 configured to cool the gas mixture 3 in a cooling space. For example, the cold source 15 comprises a cooling element. By cold source, it can be meant a source enabling the enclosure 11 to be cooled from the room temperature of the engine. By hot source, it can be meant a source enabling the enclosure 11 to be heated from a room temperature of the engine.

Preferably, the heating element and/or the cooling element belong to the engine.

The system comprises a movable element 12 configured to move inside the enclosure 11. For the sake of clarity, the hot source 14 and the cold source 15 have not been represented in the figures.

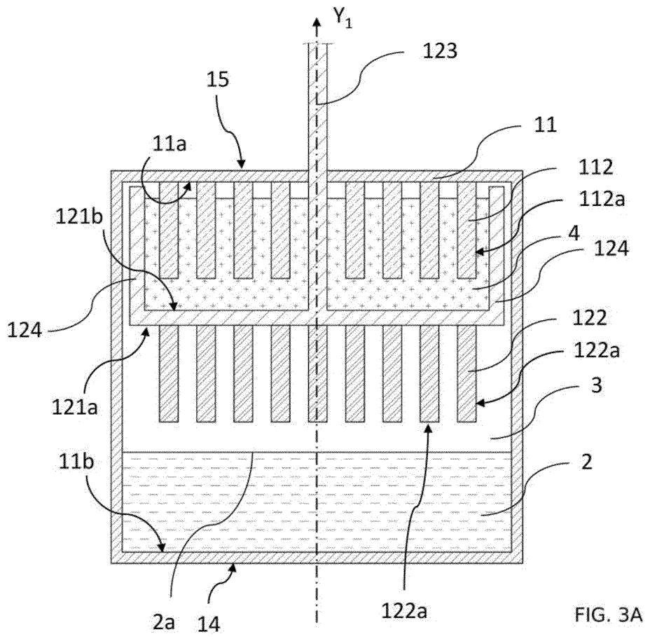

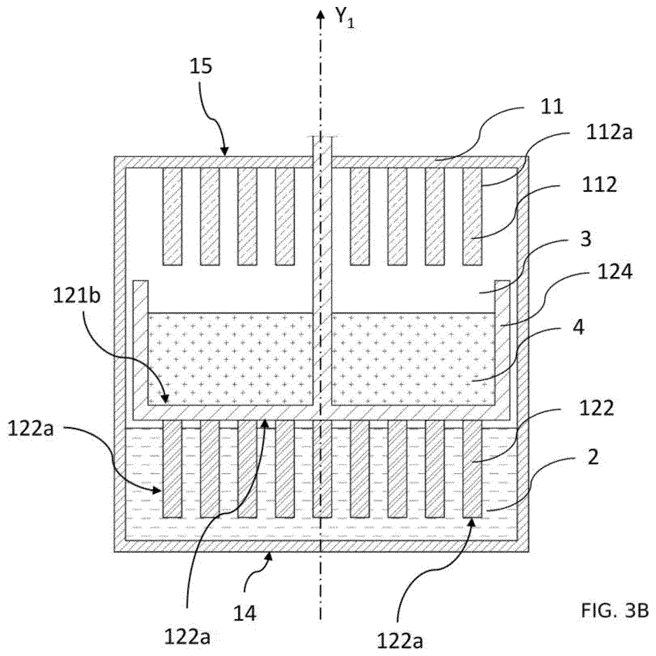

According a first embodiment represented in FIGS. 2A-3B, the movable element 12 is configured to translationally move along the main axis Y₁. The movable element 12 preferably comprises a main portion 121 located at the end of a drive shaft 123. According to one example, in the first configuration, the main portion 121 is closer to the heating zone and therefore to the liquid 2. In the second configuration, the main portion 121 is further away from the heating zone and therefore more distant from the liquid 2 than in the first configuration. The heating zone being distinct and distant from the cooling zone and the first configuration being different from the second configuration.

Preferably, evaporation of the liquid 2 takes place at the surface area 2a of the liquid in contact with the gas mixture 3. The amount of liquid 2 evaporated being proportional to said surface area 2a.

According to one example, in the second configuration, said portion of the liquid entirely evaporates in contact with the gas mixture. According to an alternative example, in the second configuration, said portion of the liquid partially evaporates in contact with the gas mixture. Advantageously, the liquid 2 is hot water. The use of water being especially known for its very high heat capacity. Other liquids having optimal evaporation capacities relative to their temperature, such as for example alcohol, may also be used.

According to one example, the gas mixture 3 is water vapour. It can also be vapour of other mixtures, whose liquid states have evaporation temperatures different from the evaporation temperature of water.

As illustrated in FIGS. 2A-2B and according to a preferred embodiment of the present invention, the movable element 12 comprises at least one plunger element 122. Preferably, the movable element 12 comprises a plurality of plunger elements 122. The plunger elements 122 being configured so as to be at least partially immersed in the liquid 2 in a first configuration represented in FIG. 2B and alternatively not immersed or less immersed in the liquid 2 and more in contact with the gas mixture 3 in a second configuration than in the first configuration represented in FIG. 2A. According to this embodiment, the plunger elements 122 are configured to translationally move along the main axis Y₁.

Preferably, at least one plunger 122 includes a porous surface 122a configured to be impregnated with the liquid 2 so as to increase the area of liquid 2 in contact with the gas mixture 3 and amplify the evaporation phase. As a result, the efficiency of the system is optimised. By porous surface 122a, it is meant a surface having hollows, being preferably concave, spaced apart from each other, also called pores or retention cavities. These hollows can thus form a volume with respect to the surface 122a of the at least one plunger 122. The volume can then be capable of receiving a liquid enabling the increase of the area of the liquid 2 in contact with the gas mixture 3. Thus, the liquid does not pass through the plunger element 122 neither from one side to the other nor to its centre. The liquid 2 remains confined to the porous surface 122a and the retention cavities formed by the pores of the porous surface 122a.

According to one example, the liquid retention cavities formed by the pores of the plunger element 122 have a maximum dimension Dpores such that Dpores<1.5 mm (10-3 metre), preferably Dpores<1 mm, preferably Dpores<0.8 mm, preferably Dpores<0.5 mm, preferably Dpores<0.3 mm. With these pore dimensions, the liquid retention area and therefore evaporation are increased. Furthermore, this does not disrupt circulation of fluids. Nor does it unnecessarily weigh down the plunger 122 by loading it with an amount of liquid 2 that does not have time to evaporate. The kinetics of the system 1 is therefore improved. Its performance is increased. Thus, the pores have a smaller dimension compared to the dimension between two plunger elements 122. Dpores is the maximum dimension in a least one dimension, preferably, Dpores is the maximum dimension created by the opening of the pore at the surface of the porous surface 122a. If the pores are portions of a sphere, then Dpores corresponds to the diameter of the circle formed by the opening of the pore at the surface of the porous surface 122a.

When the displacer 12 moves away from the heating zone, it exposes the plunger elements 122 to the gas mixture so as to promote evaporation of the liquid 2 soaked on the porous surfaces 122a. By imbibing, it is meant the penetration of the liquid, for example, into the pores present on the porous surfaces 122a of the plungers 122.

When the displacer 12 moves away from the cooling zone, it exposes the plunger elements 122 to the gas mixture 3 in the cooling zone for the condensation phenomenon.

When the engine operates, the plunger elements 122 are alternatively immersed in and taken out of the liquid 2 by being driven by the movable element 12.

During the immersion phase, which corresponds to the first configuration, the porous surfaces 122a of the plunger elements 122 capture heat of the liquid 2, known as the “heating fluid”. The at least one porous surface 122a being immersed in the liquid 2 so as to be impregnated with the same.

During the evaporation phase corresponding to the second configuration, the plunger elements 122 come out of the liquid 2 so that the at least one porous surface 122a soaked with hot liquid 2 becomes uncovered in contact with the gas mixture 3 to enable optimal evaporation.

Preferably, the plunger elements 122 comprise porous surfaces 122a respectively, and the total of these porous surfaces 122a is preferably greater than the surface area 2a of the liquid 2. Thus, all of the porous surfaces 122a are added to the surface area 2a in order to optimise evaporation of the liquid 2.

This process can also be reproduced by analogy to increase condensation of a volume of liquid 2 evaporated. In this case, the liquid 2 in which the plunger elements 122 are immersed, is cooled. As illustrated in FIGS. 3A-3B and in the same way as in the previous embodiment, the movable element 12 comprises plunger elements 122 fastened to the lower face 121a and configured to be immersed in the hot liquid 2 in the heating space.

According to this embodiment, the movable element 12 comprises a rim 124 and an upper face 121b. Preferably, the upper face 121b being a face opposite and parallel to the lower face 121a. The rim 124 extending from the upper face 121b so as to define a volume also referred to as a reservoir 121c capable of containing an additional liquid 4.

Thus, the system alternates between two configurations:
a first configuration illustrated in FIG. 3B, in which the plunger elements 122 are immersed in the liquid 2 and the additional plungers 112 are uncovered. In this configuration, the soaked surfaces of the uncovered additional plungers 112 are cold because they have just been soaked in the additional liquid 4 in proximity to the cold source. They then transmit negative heat, contributing to the condensation of the gas mixture 3. In this configuration, the surfaces of the plunger elements 122 are in the liquid 2 and have no influence on this condensation configuration.
A second configuration, illustrated in FIG. 3A, in which the surfaces of the plunger elements 122 are uncovered and the additional plungers 112 are in the additional liquid 4. In this configuration, the surfaces of the plunger elements 122 are soaked with hot liquid and thus transmit evaporation energy. The additional plungers do not influence evaporation during this evaporation configuration because they are dipped in the additional liquid 4.

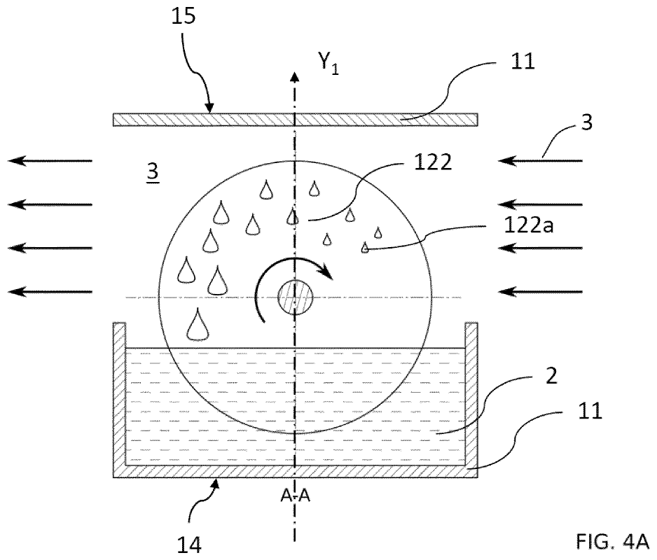

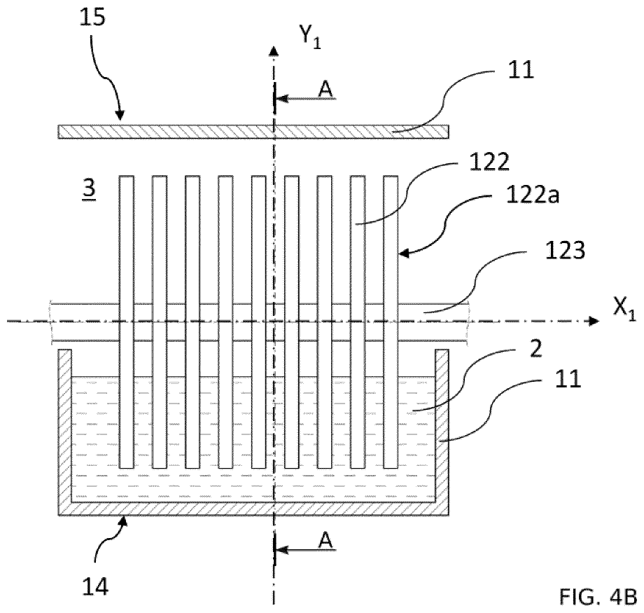

As illustrated in FIGS. 4A-4B and according to one embodiment, the at least one plunger 122 is rotationally driven to alternately switch from the first configuration to the second configuration. The plunger elements 122, for example, having a disk shape and advantageously the disks comprise a portion with a porous surface 122a. The porous surface 122a having a surface appearance comprising pores in the same manner as defined previously.

The disks are mounted to a drive shaft 123 so that they can be rotationally driven along a transverse direction X1. The transverse direction X1 preferably being orthogonal to the main axis Y₁.

Due to the rotational motion of the movable element 12 along the transverse direction X₁, the porous surface 122a is, in a first step, immersed in the liquid 2 and, in a second step, the porous surface 122a is soaked with the liquid 2 while being uncovered.

Thus, dipping the disks in the liquid 2 results in soaking of the porous surfaces 122a. Said porous surfaces 122a soaked and out of the water are then advantageously stirred by an air flow so as to accelerate the evaporation phase. This evaporation phase being amplified by the presence of the porous surfaces 122a of the disks, which are added to the surface area 2a of the liquid 2.

Thus, evaporation is maintained by rotation of the plunger elements 122 in the liquid 2. The plunger elements 122 are exposed to an air flow. For the condensation phase, the embodiment is identical but with cold water.

Several optional characteristics of the engine will be described below. All these optional characteristics are compatible and can be combined with each of the embodiments described above, in particular with each of the embodiments in which the plungers are translationally or rotationally driven.

Preferably, the heat source can be one of the following elements: an oven, a heat point, a heating resistance, a solar heat source, a waste heat source, heat from thermal batteries.

The hot source being advantageously positioned all around and/or below the heating zone so as to enable the most efficient possible temperature rise. The hot source can be obtained by exchange of working liquid with new hot liquid in a closed circuit so as to keep the operating pressure. The hot source can also be a coil inside the engine.

According to one embodiment, the enclosure 11 is a hollow cylinder extending along the main axis Y₁ and the heating zone is located at a first end of the cylinder along the main axis Y₁. The enclosure 11 advantageously extends between a lower enclosure face 11b and an upper enclosure face 11a along the main axis Y₁. The movable element being guided by its transmission axis.

Preferably, the heat source is distributed below the hollow cylinder, on the side of the first end and/or around the periphery of the cylinder.

Preferably, the cold source can be one of the following elements: a refrigeration system, a Peltier module, cooling fins, a radiator.

The cold source being advantageously positioned all around the cooling zone so as to enable the most efficient possible temperature drop. The cold source can be a flow of cold liquid inside the engine coming from outside and maintained at the operating pressure in a closed circuit.

According to one embodiment, the enclosure 11 is a hollow cylinder extending along the main axis Y₁ and the cooling zone is located at a second end of the cylinder along the main axis Y₁. Preferably, the cold source is distributed above the hollow cylinder, on the side of the second end and/or around the periphery of the cylinder.

The porous surface 122a is configured to retain liquid when the at least one plunger is immersed. This porous surface thus forms liquid retention cavities or pores as defined above.

The porous surface 122a can be formed by the outer material of the at least one plunger element 122. This material can be porous. A porous material can thus be understood as having pores as defined above. For example, it can be materials such as wood, oxidised metal, paper, fabric, porous composite materials or a spongy material. Thus, the plunger element 122 may for example comprise a non-porous body and a coating, covering the body and forming the porous surface 122a. The thickness of the body is for example 3 times, or even 5, or even 10 times greater than the porous surface 122a.

Alternatively, the porous surface may be formed by reliefs present on the plunger element. For example, these reliefs may be formed by: ridges, grooves, strips, grids, sticks or a mesh. For example, the grooves or ridges may extend along a direction parallel to the main axis Y₁ perpendicular to the translation direction if the movable element is translational or along radii of the disk if the movable element 12 is rotational. It shall be noted that the presence of reliefs can be combined with the use of a porous material.

According to one example, the porous surface of the at least one plunger element is entirely made of a porous material and takes the shape of at least one of the following typologies: ridges, strips, grids, sticks, sponges or a mesh. The reliefs forming the typology have a maximum dimension Drelief such that Drelief≥3*Dpores, preferably, Drelief≥5*Dpores, more preferably, Drelief≥10*Dpores. According to one example, Drelief>1 mm (10-3 metre). According to one example, Drelief>2 mm (10-3 metre). According to one example, Drelief>5 mm (10-3 metre). According to one example, Drelief>10 mm (10-3 metre). Drelief is measured in a least one dimension. The presence of these reliefs makes it possible to further increase the developed area of the porous surface 122a. This makes it possible to increase the exchange area to enhance evaporation. This makes it possible to improve the performance of the system 1.

This type of typology makes it possible to generate a set of voids capable of filling with fluid. Wood can be used. Wood is advantageously porous by nature, since due to its structure, it has fibres having voids with a spongy capacity. Preferentially, wood makes it possible to sponge up the fluid and is an unexpected material in an engine. Wood has the advantage of being an excellent thermal insulator suitable for good engine efficiency.

The formal typology of the plunger elements is such as to increase the soaked area from which the liquid is taken, while maintaining the same cavity volume.

A porous material or porous surface can be understood as a solid material comprising a plurality of cavities being capable of filling with fluid.

According to one example, the engine comprises a plurality of plunger elements 122. These can be cylindrical tubes, preferably solid and alternatively hollow. The plunger elements 122 may be distant so as to create a space for the flow of gas mixture to pass through.

The plunger elements are advantageously rods whose diameter is less than or equal to the diameter of the displacer. Preferably, the diameter of a plunger element 122 is at least twice less, preferably at least four times less than the external diameter of the movable element 12. Along the main axis Y₁, the plunger elements should preferably be dimensioned according to the material of which they are made so that the operating conditions of the engine do not make them deflect.

According to one example, the plunger elements are hollow and preferably have openings to enable easier discharge of the liquid 2.

According to one example, the plunger element 122 comprises a porous surface 122a. The plunger element 122 can be entirely covered with the porous surface 122a. The plunger element 122 can be covered with a fabric. The porous surface 122a can be made of one the following materials: oxidised metal, wood, a composite material having cavities. Which thus increases the exchange area to enhance evaporation. This makes it possible to improve the performance of the system 1.

Advantageously, the plunger element can be made of a natural or synthetic sponge or a similar material having a high liquid absorption capacity.

Preferably, the plunger element has a thermal conductivity of less than or equal to 226 W·m⁻¹. K, preferably a thermal conductivity of less than or equal to 100 W·m⁻¹·K⁻¹, preferably less than or equal to 10 W·m⁻¹·K⁻¹, preferably less than or equal to 1 W·m⁻¹·K⁻¹. Preferably, the plunger element, or at least the material forming the porous surface, has a thermal conductivity of less than 10 W·m⁻¹·K⁻¹, preferably less than 8 W·m⁻¹·K⁻¹, preferably less than 5 W·m⁻¹·K⁻¹, preferably less than 1 W·m⁻¹·K⁻¹. Thus, the plunger elements do not have the function of conducting heat. The plunger element 122 advantageously has a thermal conductivity of less than or equal to 10 W·m⁻¹·K⁻¹ so as not to disrupt the evaporation and condensation phases with the gas mixture. Evaporation of the liquid would cool a plunger element 122 having a high thermal conductivity and would cool the heating liquid 2 when it is reintegrated into the liquid 2.

Preferably, the plunger element 122, or at least the material forming the porous surface, can be made of wood. Thus, the plunger element 122 can be entirely made of wood, that is, the only material in its thickness is wood. Alternatively, it can be made of a first material covered with wood. Thus, the plunger element 122 may have a thermal conductivity of between 0,035 and 0.049 W·m⁻¹·K⁻¹. Thus, a plunger element 122 is obtained having a porous material and minimised thermal conductivity enabling better evaporation of the liquid 2.

According to a particular embodiment, the plunger elements 122 are small identical elementary volumes.

According to a particular embodiment, the movable element 12 and the plunger elements 122 form a single monolithic part.

According to a particular embodiment, the movable element 12 is configured so as to alternately pass the gas from the heating space to the cooling space.

The invention is not limited to the previously-described embodiments and covers all of the embodiments covered by the claims.

### Reference numerals

1/Differential evaporation engine system
11/enclosure
11a/upper enclosure face
11b/lower enclosure face
112/additional plunger elements
12/movable element
121a/lower surface
121b/upper surface
122/plunger element
122a/porous surface
123/drive shaft
124/rim
14/hot source
15/cold source
2/liquid
2a/surface area
3/gas mixture
4/additional liquid
Y₁/Main axis
X₁/Transverse axis

1. A differential evaporation engine system comprising:
an enclosure having a cavity capable of containing a liquid and a gas mixture,
a hot source configured to heat the liquid,
a cold source configured to cool the gas mixture, and
a movable element configured to move inside the enclosure, the movable element comprising at least one plunger element, the plunger element being configured so as to be at least partially immersed in the liquid in a first configuration and alternatively in contact with the gas mixture in a second configuration, the second configuration being different from the first configuration, in the second configuration, the plunger element not being immersed in the liquid or being less immersed in the liquid than in the first configuration, wherein the at least one plunger element has a porous surface, the plunger element being configured so that, in the first configuration, the porous surface is impregnated with a portion of the liquid and, in the second configuration, said portion of the liquid evaporates at least partially in contact with the gas mixture.

2. The system according to claim 1, wherein the enclosure is configured so that the liquid has the gas thereabove along a main axis and that the movable element moves in a translational motion along the main axis.

3. The system according to claim 2, wherein the plunger element mainly extends along a direction parallel to the main axis.

4. The system according to claim 1, wherein the movable element comprises a main portion having a lower surface normal to a main axis and the at least one plunger element extends from the lower surface.

5. The system according to claim 1, wherein the enclosure comprises at least one additional plunger element fixed relative to the enclosure and having an additional porous surface portion, the at least one additional plunger element extending into the enclosure from a lower enclosure face of the enclosure along a direction parallel to a main axis.

6. The system according to claim 1, wherein a main portion of the movable element defines a reservoir configured to contain an additional liquid and the engine is configured so that, in the second configuration, an at least one additional plunger element is soaked with the additional liquid.

7. The system according to claim 1, further comprising a plurality of additional plunger elements.

8. The system according to claim 1, wherein the enclosure is configured so that the liquid has the gas thereabove along a main axis and that the movable element moves in a rotational motion along a secondary axis, orthogonal to the main axis.

9. The system according to claim 1, wherein the porous surface covers an entire surface of the at least one plunger element.

10. The system according to claim 1, wherein the engine comprises a plurality of plunger elements.

11. The system according to claim 1, wherein the plunger elements are distant from one another so as to create a space for the gas to pass through in order to optimise the evaporation of the liquid soaked on the porous surface by contact with the gas.

12. The system according to claim 11, wherein the plunger elements are equidistant from one another.

13. The system according to claim 1, wherein the at least one plunger element is a rod and/or a cylinder.

14. The system according to claim 1, wherein the plunger element has a hollow portion.

15. The system according to claim 1, wherein at least one plunger element has at least one opening configured to enable a circulation of the gas mixture as the system passes from one of the first configuration and the second configuration to the other of the first configuration and the second configuration.

16. The system according to claim 1, wherein the plunger element or the porous surface of the plunger element is made of wood or a composite material or sponge or a fabric.

17. The system according to claim 1, wherein the plunger element or the porous surface of the plunger element is made of oxidised metal.

18. The system according to claim 1, wherein the plunger element is made of a material having a thermal conductivity of less than or equal to 10 W·m^{31 1}·K⁻¹.

19. The system according to claim 1, wherein the porous surface of the at least one plunger element is entirely made of a porous material and takes the a shape of at least one of the following typologies: ridges, strips, grids, sticks, sponges or a mesh.

20. The system according to claim 1, wherein the cavity has a constant volume and extends along a main axis between a heating space and a cooling space so that the hot source can heat the liquid in the heating space via a side and/or lower faces and the cold source can cool the gas mixture in the cooling space.

21. (canceled)
